(19) United States
(12) Patent Application Publication
(10) Pub. No.: US 2018/0162741 A1
(43) Pub. Date: Jun. 14, 2018

(54) METHOD OF REMOVING YTTRIUM FROM YTTRIUM-CONTAINING EUROPIUM OXIDE

(71) Applicant: NATIONAL CHUNG SHAN INSTITUTE OF SCIENCE AND TECHNOLOGY, TAOYUAN CITY (TW)

(72) Inventors: TUNG-CHUN WU, TAOYUAN CITY (TW); HSIOU-JENG SHY, TAOYUAN CITY (TW); CHING-YU TSO, TAOYUAN CITY (TW); SHIEN-JEN YANG, TAINAN CITY (TW)

(21) Appl. No.: 15/372,573

(22) Filed: Dec. 8, 2016

(51) Int. Cl. C01F 17/00; B01D 9/00; C25B 1/00; C22B 3/04; C22B 3/22; C22B 59/00

(52) U.S. Cl. CPC C01F 17/0043; B01D 9/0004; C22B 59/00; C22B 3/04; C22B 3/22; C25B 1/00

(57) ABSTRACT

A purifying method of removing yttrium from a yttrium-containing europium oxide, including the steps of (A) dissolving a yttrium-containing europium oxide in a solvent to produce a saturated yttrium-containing europium compound solution; (B) performing a low-temperature recrystallization treatment on the saturated yttrium-containing europium compound solution to produce a europium-containing precipitate; (C) calcining the europium-containing precipitate, followed by dissolving the calcined europium-containing precipitate in an inorganic acid to produce a europium-containing metal functioning as an electrolyte; and (D) performing an electrochemical reduction process on the electrolyte which the europium-containing metal functions as, followed by introducing a precipitant thereto to produce a europium compound. The method removes yttrium from yttrium-containing europium oxide present in phosphor powder to purify europium oxide, thereby recycling, purifying and reusing europium valuable metal to reduce environmental pollution.

### FIELD OF THE INVENTION

The present invention relates to purification methods and, more particularly, to a purifying method of removing yttrium from a yttrium-containing europium oxide.

### BACKGROUND OF THE INVENTION

Rare earth elements abound in, and account for 0.0153% of the weight of, the Earth's crust. They approximate to common metals, such as zinc, tin, and cobalt, in terms of resource quantity. As the name suggests, rare earth elements are rare in the soil of the Earth's crust. Among rare earth elements, cerium ranks first in resource quantity (0.0046%), then come yttrium, neodymium, and lanthanum. Regarding their concentration, most rare earth elements are of a weight percentage of less than 1.0 wt %, with a maximum weight percentage of 4-9 wt %; hence, not only does rare earth element mining and processing incur high costs, but it is also difficult to obtain highly pure rare earth elements. Unless its selling price is high, heavy use of a rare earth element will not be cost-efficient. Nonetheless, rare earth elements are indispensable to daily life, and are used in the manufacturing of vehicle catalyst converters, petroleum refinery-oriented catalysts, magnetic materials for use in producing permanent magnets, lighter's thunderstone, dyes for use with glass and ceramics, and high-tech applications, such as parts and components for use by the aerospace industry, electronic product manufacturing, laser-related applications, nuclear energy-related industry, and superconductors. When it comes to metallurgy, rare earth elements greatly enhance the performance of steel, aluminum, magnesium, titanium, and alloys thereof. Hence, although the global trade of rare earth elements is presently carried out for only billions USD annually, rare earth elements are the key raw material for use in high-tech industries. In view of this, major industrial countries see rare earth elements as their strategic resources, dubbing rare earth elements as “industrial vitamins,” “mother of novel materials” and “21^{st} century's gold,” and naming rare earth element-related industry “sun industry”.

Unfortunately, China accounts for 97% of the global supply of rare earth elements. More badly, under her green policies, China is cutting her export of rare earth elements and raising the selling prices of rare earth element metals, thereby leading to price tension and uncertainties in high-tech markets worldwide. Rare earth element metals are applies to sophisticated parts and components of advanced electronic products, such as fuel cells, cell phones, display units, and high-capacity batteries, as well as permanent magnet wind power generation and green energy-powered equipment; hence, the global demand for rare earth elements is ever-increasing. As a result, plenty of countries resort to recycling rare earth elements from consumer product wastes, industrial wastes, and spent products which contain rare earth elements. In this regard, up to year 2011, the rare earth elements recycled account for less than 1% of rare earth elements in use, because of low collection efficiency.

To get in line with the trend toward green houses and offices, light-emitting diodes (LED) are replacing conventional fluorescent lamps. According to the prior art, phosphor powder is indispensable to white LED, HCFL, and CCFL. Rare earth elements commonly for use in manufacturing phosphor powder include yttrium, cerium, europium, and terbium, and thus they are increasingly in need. Legislation speeds up the consumption of rare earth elements. For instance, an Australian ban imposed on incandescent lamps in 2010 is echoed by policy-makers in California and Alaska of the United States and China. Given the green trend of late, a huge amount of rare earth elements is going to be consumed by rare earth element-based lighting and display units, and rare earth element consumption will double in the next five years. Therefore, rare earth element recycling is a future trend under which 10 to 15% of the supplied rare earth elements will eventually originate from recycled materials to effectively render their selling prices reasonable.

Conventional techniques of recycling waste metals include fired melting. Fired melting involves melting and refining renewed metal resources or vaporizing a target metal; the former is known as melting refining, and the latter is known as vaporizing refining. But vaporizing refining is restricted to a few metals of high volatility; hence, most metals have to undergo melting refining exemplified by high-temperature oxidation, reduction, and melting electrolysis. In this regard, valuable metals, such as yttrium and europium, have high melting points and thus take up much energy when undergoing melting refining, thereby incurring high recycling costs.

Accordingly, it is important for the industrial sector to provide a method of removing rare earth elements from phosphor powder, and particularly removing europium-containing valuable metals from phosphor powder, so as to reduce the demand for energy-intensive melting refining and thereby strike a balance between process cost control and environmental protection.

### SUMMARY OF THE INVENTION

In view of the aforesaid drawbacks of the prior art, it is an objective of the present invention to provide a purifying method of removing yttrium from a yttrium-containing europium oxide to integrate a yttrium-containing europium oxide, an inorganic acid, an electrochemical reduction process, and a solvent such that europium oxide is effectively recycled from phosphor powder and then purified.

In order to achieve the above and other objectives, the present invention provides a purifying method of removing yttrium from a yttrium-containing europium oxide, comprising the steps of: (A) dissolving a europium oxide in a solvent to produce a saturated yttrium-containing europium compound solution; (B) performing a low-temperature recrystallization treatment on the saturated yttrium-containing europium compound solution to produce a europium-containing precipitate; (C) calcining the europium-containing precipitate, followed by dissolving the calcined europium-containing precipitate in an inorganic acid to produce a europium-containing metal functioning as an electrolyte; and (D) performing an electrochemical reduction process on the electrolyte which the europium-containing metal functions as, followed by introducing a precipitant thereto to produce a europium compound.

In step (A), the solvent is a nitrate-containing (but the present invention is not limited thereto) saturated yttrium-containing europium compound solution, wherein yttrium-containing europium oxide reacts with the solvent (nitrate) to produce a yttrium-containing europium compound solution. The yttrium-containing europium compound solution is a saturated yttrium-containing europium nitrate solution.

In step (B), the low-temperature recrystallization treatment cools down the saturated yttrium-containing europium compound solution so that the europium-containing precipitate is obtained by recrystallization. Since the saturated yttrium-containing europium compound solution includes a saturated europium nitrate solution and an unsaturated nitrate yttrium solution, the europium-containing precipitate obtained by recrystallization must include europium nitrate, and a low degree of precipitation occurs to the unsaturated nitrate yttrium solution by recrystallization. Hence, yttrium is removed from the yttrium-containing europium oxide, wherein the solvent is not restricted to nitrates, and the europium compound is not restricted to europium nitrate.

In step (C), the calcination process entails calcining the europium-containing precipitate at around 1000° C. (but the present invention is not limited thereto) to produce europium oxide, and then the europium oxide is dissolved in HCl (but the present invention is not limited thereto) to form an electrolyte. In step (D), the electrochemical reduction process requires a platinum netting cathode and a platinum netting anode. In step (D), the precipitant is ammonium sulfate (but the present invention is not limited thereto). After the electrolyte has undergone the electrochemical reduction process and been provided with the precipitant, a europium compound precipitates (the europium compound is europium (II) sulfate). Then, the electrolyte which the europium-containing compound functions as is filtered and calcined again at 1000° C. to produce highly pure yttrium-free europium oxide.

The above summary, the description below, and the accompanying diagram further explain the means and measures taken to fulfill the predetermined objectives of the present invention and the effect thereof. The other objectives and advantages of the present invention are described below and illustrated by the accompanying diagram.

### BRIEF DESCRIPTION OF THE DRAWINGS

FIG. 1 is a flow chart of a purifying method of removing yttrium from a yttrium-containing europium oxide according to the present invention.

### DETAILED DESCRIPTION OF THE PREFERRED EMBODIMENTS

The present invention is hereunder illustrated with specific preferred embodiments so that persons skilled in the art can gain insight into the features and advantages of the present invention.

The method of the present invention employs techniques, namely high-temperature saturated dissolution, low-temperature recrystallization, electrochemical reduction, and selective precipitation, to remove yttrium from yttrium-containing europium oxide for purification. The method of the present invention is efficient, requires a simple process, incurs low costs, and facilitates mass production. In general, metallic nitrates, including europium nitrate, are readily soluble in water. In this regard, the solubility of europium nitrate in water increases greatly with temperature. Given the high solubility of europium nitrate in water, in the embodiments of the present invention, europium oxide reacts with and thus dissolves in a nitrate at a high temperature until the resultant europium nitrate reaches a saturated state. Then, the europium nitrate is cooled down to lower the solubility of the europium nitrate and thus allow the europium nitrate to precipitate, thereby achieving purification of europium. Finally, the purified europium is oxidized to produce highly pure europium oxide. On the other hand, the embodiments of the present invention entail dissolving yttrium-containing europium oxide in HCl, using Y3+-Eu3+-containing solution as an electrolyte, using platinum as cathode and anode, and introducing a current at a selected voltage; meanwhile, the reaction of Eu3+→Eu2+ occurs, but Y3+ does not undergo any reduction reaction. Afterward, the precipitant, such as ammonium sulfate, is added to the solution to precipitate EuSO₄, wherein neither Y3++ nor Eu3+ precipitates, thereby achieving removal of yttrium.

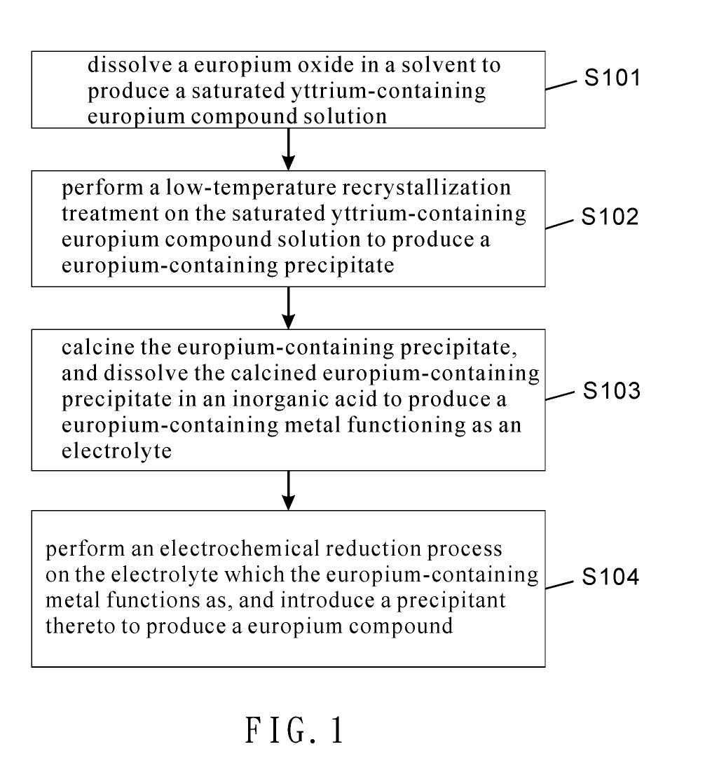

Referring to FIG. 1, there is shown a flow chart of a purifying method of removing yttrium from a yttrium-containing europium oxide according to the present invention. As shown in the diagram, the present invention provides a purifying method of removing yttrium from a yttrium-containing europium oxide, comprising the steps of: (A) dissolving a yttrium-containing europium oxide in a solvent to produce a saturated yttrium-containing europium compound solution S101; (B) performing a low-temperature recrystallization treatment on the saturated yttrium-containing europium compound solution to produce a europium-containing precipitate S102; (C) calcining the europium-containing precipitate in an inorganic acid to produce a europium-containing metal functioning as an electrolyte S103; and (D) performing an electrochemical reduction process on the electrolyte which the europium-containing metal functions as, followed by introducing a precipitant thereto to produce a europium compound, wherein the europium compound is filtered and calcined again to produce highly pure europium oxide S104. The saturated yttrium-containing europium compound solution includes a saturated yttrium-containing europium compound solution.

### Embodiment

To verify the effectiveness of the steps of the method of the present invention, experiments are conducted against different criteria and parameters, as shown in Table 1. Embodiments 1, 2, 3 involve dissolving a raw material (yttrium-containing europium oxide) at different temperatures, cooling down it, performing recrystallization on it at different temperatures, and calcining it at a high temperature (around 1000° C.) to turn it into an oxide, wherein the raw material (yttrium-containing europium oxide) has the following constituents: europium oxide (95.00 wt %) and yttrium oxide (5.00 wt %). Embodiment 1 entails producing a saturated europium nitrate solution (saturated yttrium-containing europium compound solution) at 60° C., and then cooling it to 20° C.; and the result shows that the purity of the europium oxide increases from 95.0 wt % to 98.50 wt %, thereby verifying that element purity is increased by high-temperature dissolution and low-temperature crystallization. Embodiment 2 entails producing a saturated europium nitrate solution at 60° C. and then cooling it to 0° C.; and the result shows that the purity of the europium oxide increases from 95.00 wt % to 99.09 wt %, whereas the concentration of impurities decreases significantly. Embodiment 3 entails producing a saturated europium nitrate solution at 80° C. and then cooling it to 0° C.; and the result shows that, in the sample, the europium oxide in Embodiment 3 has higher purity than their counterparts in Embodiments 1, 2. The aforesaid experiments verify that element purity is increased by high-temperature dissolution and low-temperature crystallization.

TABLE 1
parameters for recrystallization and results

| | Embodi- | Embodi- | Embodi- |
|---|---|---|---|
| | ment 1 | ment 2 | ment 3 |
| dissolution temperature ° C. | 60 | 60 | 80 |
| recrystallization temperature ° C. | 20 | 0 | 0 |
| europium oxide wt % | 98.50 | 99.09 | 99.43 |
| yttrium oxide wt % | 1.50 | 0.91 | 0.57 |

The europium-containing precipitate (europium oxide with a purity of 99.09 wt %) of Embodiment 2 is used as a raw material and dissolved in HCl to function as an electrolyte for undergoing electrochemical reduction for 24 hours. Then, ammonium sulfate functions as a precipitant, and the resultant europium (II) sulfate is calcined at a high temperature (around 1000° C.) to form an oxide (the criteria and result are shown in Table 3). Embodiment 4 entails dissolving 100 g of the raw material in HCl, applying a voltage of 4V to it to perform thereon electrochemical reduction, and after 24 hours, introducing to it ammonium sulfate to precipitate europium (II) sulfate, calcining it at a high temperature, measuring its total weight, and performing element analysis; and the result shows that the purity of the europium oxide increases from 99.09 wt % to 99.93%, and the recycling rate is 76.2%. Embodiment 5 uses a lower sample weight but keeps the other parameters unchanged, and its result shows that the purity of the europium oxide increases from 99.09 wt % to 99.98%, which is higher than that of Embodiment 5, and its recycling rate of 85.2 is also higher than that of Embodiment 5. Embodiment 6 changes the applied voltage for electrochemical reduction (decreasing it from 4V to 3V) and thus reduces the reduction current, and in consequence the yield of Eu²⁺ decreases, causing the end product of Embodiment 6 to have a lower weight than its counterpart in Embodiment 4, but the purity 99.97% of the europium oxide of Embodiment 6 is higher than the purity 99.93% of the europium oxide of Embodiment 4. The results of Embodiment 4 through Embodiment 6 indicate that the removal of europium oxide is achieved by dissolving yttrium-containing europium oxide in HCl to function as an electrolyte, applying a voltage thereto to perform electrochemical reduction thereon, and introducing a precipitant ammonium sulfate thereto.

TABLE 3
parameters for electrochemical reduction and results

| | Embodi- | Embodi- | Embod- |
|---|---|---|---|
| | ment 4 | ment 5 | iment 6 |
| sample weight (g) | 100 | 50 | 100 |
| HCl volume (ml) | 400 | 400 | 400 |
| applied voltage (V) | 4 | 4 | 3 |
| yttrium oxide (wt %) | 0.07 | 0.02 | 0.03 |
| europium oxide (wt %) | 99.93 | 99.98 | 99.97 |
| product weight (g) | 76.2 | 42.6 | 61.3 |
| recycling rate (%) | 76.2 | 85.2 | 61.3 |

The main objective of the present invention is to increase the purity of yttrium-containing europium oxide with different criteria, such as dissolution temperature of europium oxide, crystallization temperature of europium nitrate, voltage applied to electrode, duration for applying the voltage, and types of precipitant, to remove yttrium and thus increase the purity of europium oxide. When configured appropriately, the aforesaid voltage and duration for applying the voltage together enables Eu³⁺ to be reduced and turned into Eu²⁺, without causing Y³⁺ to undergo any reduction reaction. This, coupled with the precipitant thus introduced, allows Eu²⁺ or Y³⁺ to precipitate, thereby effectuating europium purification. The method of the present invention is easy, dispenses with any apparatus characterized by intricate component operation and process, incurs low equipment costs, and thus facilitates mass production. The operation of the method of the present invention produces no waste water, dispenses with back-end waste water treatment facilities, and thus provides a recycling process which is environment-friendly.

The features and advantages of the present invention are disclosed above by preferred embodiments. The preferred embodiments are not restrictive of the present invention. Any persons skilled in the art can make some changes and modifications to the preferred embodiments without departing from the spirit and scope of the present invention. Accordingly, the legal protection for the present invention should be defined by the appended claims.

What is claimed is:

1. A purifying method of removing yttrium from a yttrium-containing europium oxide, comprising the steps of:
(A) dissolving a europium oxide in a solvent to produce a saturated yttrium-containing europium compound solution;
(B) performing a low-temperature recrystallization treatment on the saturated yttrium-containing europium compound solution to produce a europium-containing precipitate;
(C) calcining the europium-containing precipitate, followed by dissolving the calcined europium-containing precipitate in an inorganic acid to produce a europium-containing metal functioning as an electrolyte; and
(D) performing an electrochemical reduction process on the electrolyte which the europium-containing metal functions as, followed by introducing a precipitant thereto to produce a europium compound.

2. The purifying method of removing yttrium from a yttrium-containing europium oxide according to claim 1, wherein the saturated yttrium-containing europium compound solution is a saturated yttrium-containing europium nitrate solution.

3. The purifying method of removing yttrium from a yttrium-containing europium oxide according to claim 1, wherein the low-temperature recrystallization treatment cools down the saturated yttrium-containing europium compound solution to 0˜30° C. such that the europium-containing precipitate is produced by recrystallization.

4. The purifying method of removing yttrium from a yttrium-containing europium oxide according to claim 1, wherein, in step (C), the calcination process entails calcining the europium-containing precipitate at 900˜1100° C. for 1˜2 hours to produce europium oxide.

5. The purifying method of removing yttrium from a yttrium-containing europium oxide according to claim 1, wherein the electrochemical reduction process is performed with a platinum netting cathode and a platinum netting anode, a voltage of 3˜4V, and sample volume mole concentration of 0.3˜0.8M.

6. The purifying method of removing yttrium from a yttrium-containing europium oxide according to claim 1, wherein the precipitant is ammonium sulfate.

7. The purifying method of removing yttrium from a yttrium-containing europium oxide according to claim 1, wherein the europium compound is europium (II) sulfate.

8. The purifying method of removing yttrium from a yttrium-containing europium oxide according to claim 1, wherein, in step (D), the europium compound is filtered and calcined again to produce highly pure yttrium-free europium oxide.
